(19) United States
(12) Patent Application Publication
(10) Pub. No.: US 2025/0131206 A1
(43) Pub. Date: Apr. 24, 2025

(54) LARGE LANGUAGE MODEL-BASED HOME ASSISTANT

(71) Applicant: Samsung Electronics Co., Ltd., Suwon-si (KR)

(72) Inventors: Lianjun Li, McKinney, TX (US); Hao Chen, Allen, TX (US); Han Wang, Allen, TX (US); Wei Sun, Allen, TX (US); Satvir S. Bhatia, Sunnyvale, CA (US); Andrea M. Small, San Francisco, CA (US); Russell Douglas Ford, Campbell, CA (US)

(21) Appl. No.: 18/815,634

(22) Filed: Aug. 26, 2024

Related U.S. Application Data
(60) Provisional application No. 63/544,751, filed on Oct. 18, 2023.

(51) Int. Cl. G06F 40/40; G06F 16/9535; G06F 40/30

(52) U.S. Cl. CPC G06F 40/40; G06F 16/9535; G06F 40/30

(57) ABSTRACT

A method includes obtaining personal activity data of a user generated by one or more sensing devices in proximity to the user. The method also includes receiving a user query from the user via a user interface. The method further includes using a large language model (LLM) based digital assistant to generate one or more user-specific suggestions or actions based on the personal activity data and the user query, the digital assistant comprising a hierarchical multi-LLM-agent structure that includes one or more pre-trained LLMs.

### CROSS-REFERENCE TO RELATED APPLICATION(S) AND CLAIM OF PRIORITY

This application claims priority under 35 U.S.C. § 119(e) to U.S. Provisional Patent Application No. 63/544,751, filed on Oct. 18, 2023, which is hereby incorporated by reference in its entirety.

### TECHNICAL FIELD

This disclosure relates generally to wireless communications systems. Embodiments of this disclosure relate to a large language model (LLM)-based home assistant.

### BACKGROUND

The number of connected devices has grown rapidly in recent years, which has driven more companies to build smart and connected environment for users. Ambient intelligence—with the help of advanced AI, sensors and connectivity technologies—is regarded as an efficient solution to improve a user's experience at home. Meanwhile, the standard body Connectivity Standards Alliance (CSA) has introduced a standard to simplify the interoperation between devices from different venders, which opens new business opportunities in smart home industry.

### SUMMARY

Embodiments of the present disclosure provide methods and apparatuses for a large language model (LLM)-based home assistant.

In one embodiment, a method includes obtaining personal activity data of a user generated by one or more sensing devices in proximity to the user. The method also includes receiving a user query from the user via a user interface. The method further includes using a large language model (LLM) based digital assistant to generate one or more user-specific suggestions or actions based on the personal activity data and the user query, the digital assistant comprising a hierarchical multi-LLM-agent structure that includes one or more pre-trained LLMs.

In another embodiment, a device includes a transceiver and a processor operably connected to the transceiver. The processor is configured to obtain personal activity data of a user generated by one or more sensing devices in proximity to the user. The processor is also configured to receive a user query from the user via a user interface. The processor is further configured to use a LLM based digital assistant to generate one or more user-specific suggestions or actions based on the personal activity data and the user query, the digital assistant comprising a hierarchical multi-LLM-agent structure that includes one or more pre-trained LLMs.

In another embodiment, a non-transitory computer readable medium includes program code that, when executed by a processor of a device, causes the device to: obtain personal activity data of a user generated by one or more sensing devices in proximity to the user; receive a user query from the user via a user interface; and use a LLM based digital assistant to generate one or more user-specific suggestions or actions based on the personal activity data and the user query, the digital assistant comprising a hierarchical multi-LLM-agent structure that includes one or more pre-trained LLMs.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example AP according to embodiments of the present disclosure;

FIG. 2B illustrates an example STA according to embodiments of the present disclosure;

FIG. 3 illustrates an example system for a LLM-based home assistant solution according to embodiments of the present disclosure;

FIG. 4 illustrates additional details of an example sensing hub according to embodiments of the present disclosure;

FIG. 5 illustrates additional details of a home assistant module according to embodiments of the present disclosure;

FIG. 6 illustrates an example architecture for execution agents according to embodiments of the present disclosure;

FIG. 7 illustrates an example process for implementing a multi-agent home assistant system according to embodiments of the present disclosure;

FIGS. 8 through 11 illustrate example use cases for a multi-agent home assistant system according to embodiments of the present disclosure; and

FIG. 12 illustrates a flow chart of a method for implementing a LLM-based home assistant according to embodiments of the present disclosure.

### DETAILED DESCRIPTION

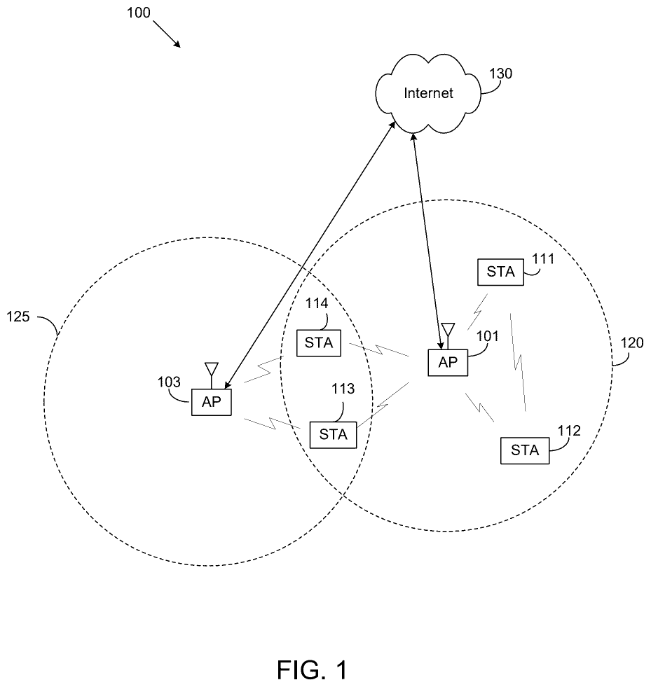

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN (wireless local area network) communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming to enable a LLM-based home assistant. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provide STAs with direct wireless broadband access to the network 130. Further, the APs 101 and/or 103 could provide access to other or additional external networks, such as external telephone networks or other types of data networks.

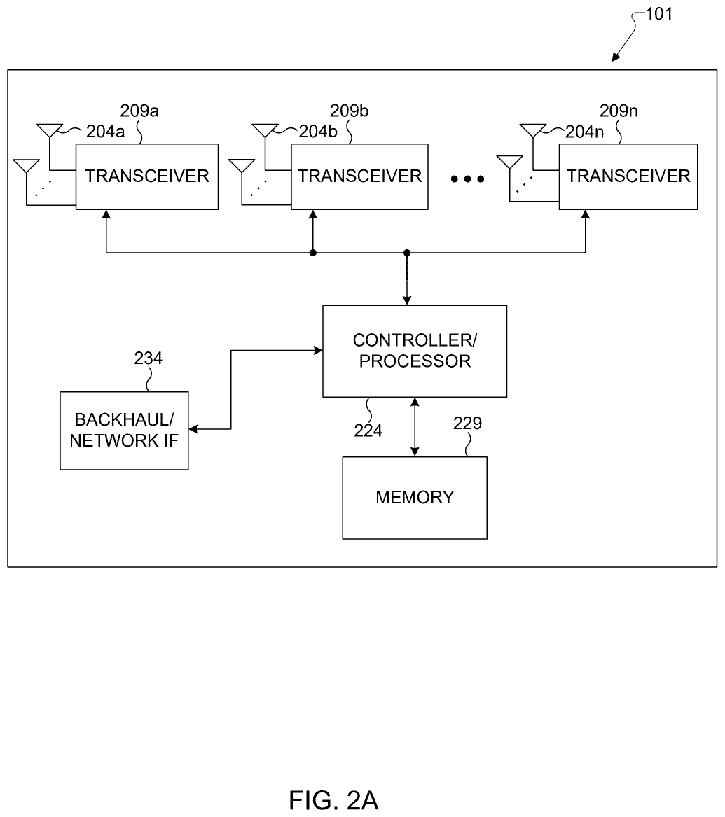

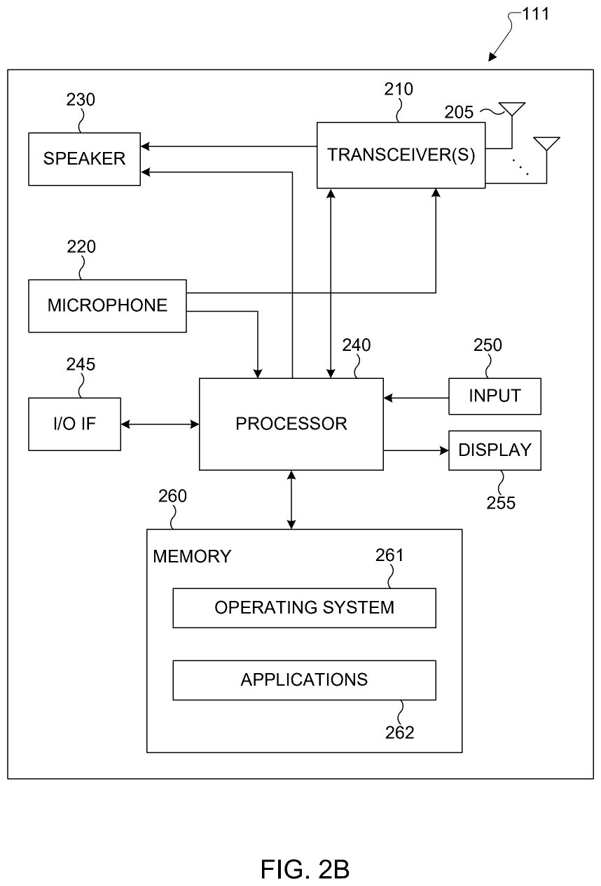

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including enabling a LLM-based home assistant. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for a LLM-based home assistant. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in certain APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 112-114 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 240 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to enable a LLM-based home assistant. In some embodiments, the processor 240 includes at least one microprocessor or microcontroller.

The processor 240 is also capable of executing other processes and programs resident in the memory 260, such as operations for enabling a LLM-based home assistant. The processor 240 can move data into or out of the memory 260 as required by an executing process. In some embodiments, the processor 240 is configured to execute a plurality of applications 262, such as applications to enable a LLM-based home assistant. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As discussed earlier, the number of connected devices has grown rapidly in recent years, which has driven more companies to build smart and connected environment for users. Ambient intelligence—with the help of advanced AI, sensors and connectivity technologies—is regarded as an efficient solution to improve a user's experience at home. Meanwhile, the standard body Connectivity Standards Alliance (CSA) has introduced a standard to simplify the interoperation between devices from different venders, which opens new business opportunities in smart home industry. Technology companies are already moving toward the ambient intelligence domain for the smart home. These companies are working toward an ambient intelligence solution that takes in multi-modality sensor information, and generates user-specific and context-aware suggestions or actions for various use cases.

In conventional solutions, the reasoning algorithm, which serves as the central logic component of ambient intelligence, is usually realized by neural networks or manually created rules. However, it is difficult to train a model or design rules that fit all users as each user has his or her own preference and living patterns. On the other hand, training a user-specific model or creating separate rules for each user requires large amounts of effort, which is not practical. Therefore, how to design a user-specific and context-aware reasoning algorithm is a key challenge of realizing ambient intelligence.

To address these and other issues, this disclosure provides systems and methods for a LLM-based home assistant. As described in more detail below, the disclosed embodiments take user history activity records and user query as inputs, and then output user-specific and context-aware suggestions or actions for various use cases. The disclosed embodiments can utilize off-the-shelf LLM models, which avoids large effort for knowledge model training or rule creation. The disclosed embodiments can generate user-specific suggestions or actions based on personal activity data of a user, which is encapsulated in one or more LLM prompts, so there is no need for the LLM model to be re-trained or fine-tuned. Details are provided below for multiple use cases such as wellness care, entertainment, energy preserving, and security. Some of the disclosed embodiments are described in the context of a home-based digital assistant, however this disclosure is not limited thereto. The disclosed embodiments can be implemented in conjunction with other suitable devices and systems.

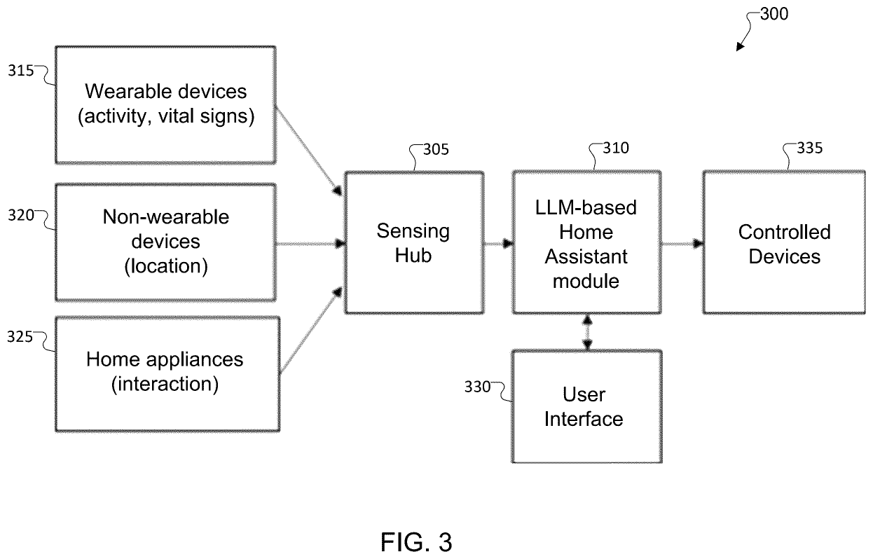

FIG. 3 illustrates an example system 300 for a LLM-based home assistant solution according to embodiments of the present disclosure. In some embodiments, the system 300 can be implemented in one or more of the components of the wireless network 100, such as the STA 111. In some embodiments, the system 300 can be implemented in a cloud server, a user application, or both.

As shown in FIG. 3, the system 300 includes a sensing hub 305 and a LLM-based home assistant module 310. The sensing hub 305 retrieves sensing signals from various sensing sources and generates user activity records. The sensing sources represent sensing devices that can generate sensing signals used for human activity inference. As shown in FIG. 3, the sensing sources can include wearable devices 315, such as a smart watch or smart phone, which could provide human vital sign and movement related information. The sensing sources can also or alternatively include non-wearable devices 320, such as an ambient motion sensor, a Wi-Fi receiving device, or radar. Such non-wearable devices 320 can provide other types of information, such as user location information. The sensing sources can also or alternatively include smart home appliances 325, such as a TV, refrigerator, or stove, which can provide user-machine interaction information.

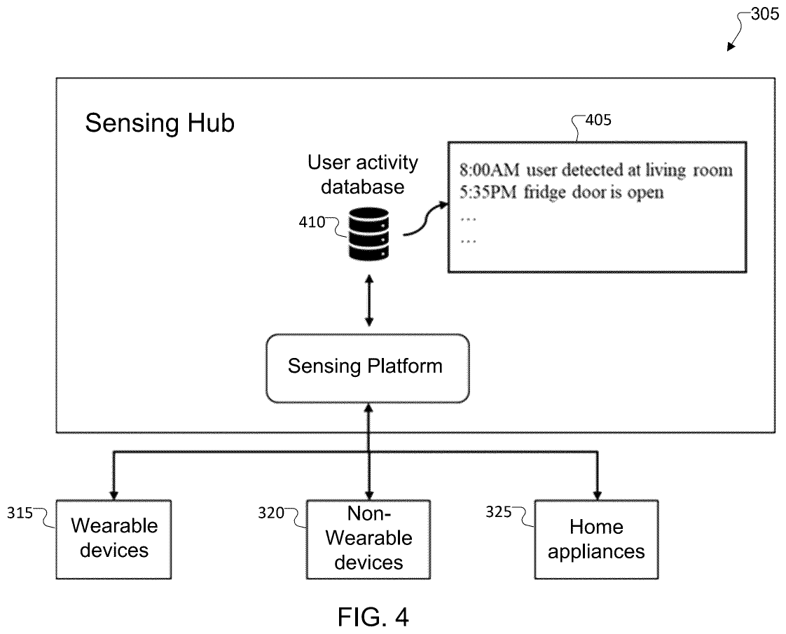

FIG. 4 illustrates additional details of an example sensing hub 305 according to embodiments of the present disclosure. As shown in FIG. 4, the sensing hub 305 operates to collect sensing information from all of the sensing sources (including the wearable devices 315, the non-wearable devices 320, and/or the smart home appliances 325), and generate user activity records 405 based on the multi-modality sensing information from the sensing sources. Examples of the user activity records 405 can include: “8:00 AM user detected at living room,” “5:35 PM fridge door is open,” and the like. The user activity records 405 can be stored locally in a database 410 or in a cloud server, allowing easy access from the system 300.

Turning again to FIG. 3, the system 300 also includes a user interface 330, which enables a user to interact with the system 300. Using the user interface 330, the user can ask questions, send commands, update preference, set routines, and the like. The format of interaction via the user interface 330 can include, but is not limited to, voice and text.

The home assistant module 310 is the central intelligence component of the system 300, and is configured as an LLM-based multi-agent system. The home assistant module 310 takes the user activity records 405 and user queries from the user interface 330 as inputs, and then leverages the reasoning capability of one or more LLMs to generate suggestions and action lists for various use cases, such as wellness care, entertainment, energy preserving, security, and the like. The home assistant module 310 can also provide control to one or more controlled devices 335 based on the user activity records 405 and the user queries. The controlled devices 335 represent devices that are connected to the smart home and can be controlled by the system 300. The list of controlled devices 335 and the scope of actions vary based on different use cases, some of which are described in greater detail below.

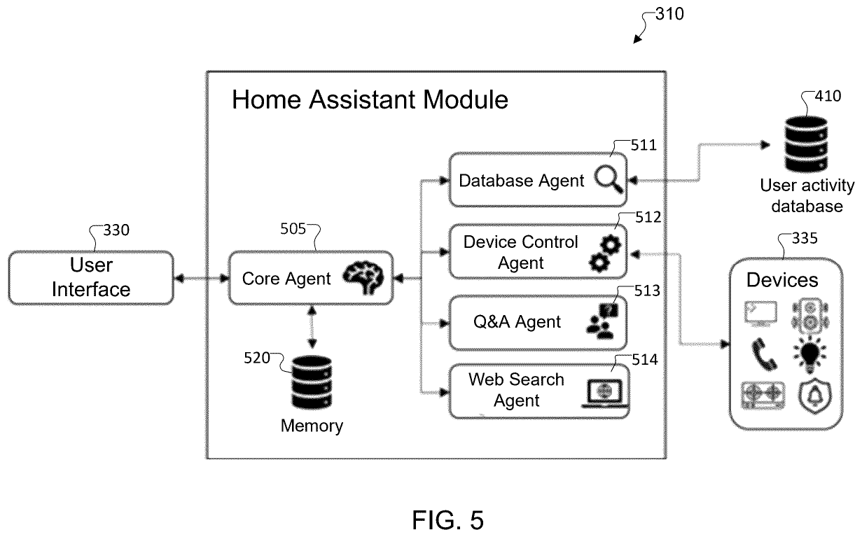

FIG. 5 illustrates additional details of a home assistant module 310 according to embodiments of the present disclosure. As shown in FIG. 5, the home assistant module 310 comprises a core agent 505 responsible for task planning based on user queries, and a set of execution agents 511-514 that complete specific tasks.

The core agent 505 interacts with the user, such as by receiving one or more user queries via the user interface 330. The core agent 505 generates and manages a list of tasks based on the user queries, and calls a corresponding execution agent 511-514 to execute the tasks sequentially. In some embodiments, the list of tasks can be stored as a task queue in a memory 520 that is accessible to the core agent 505. After the tasks are executed, the core agent 505 summarizes the execution results and provides feedback or an answer to the user. The core agent 505 can be implemented using an LLM and a prompt that defines its role and a few examples of its input/output pairs. The memory 520 can store multiple types of logs, including a history of interactions between the user and the core agent 505. For a current query, the memory 520 can also store the task queue and all interactions between the core agent 505 and the execution agents 511-514.

Examples of execution agents 511-514 include, but are not limited to, database agents 511, device control agents 512, Q&A agents 513, and web search agents 514. The database agent 511 is responsible for fetching relevant user activity records 405 from the database 410 and analyzing the user activity records 405 by generating and executing codes or scripts. The database agent 511 can be implemented using a LLM trained for code generation, and a prompt that defines its role and a few examples of its input/output pairs.

The device control agent 512 generates suitable API calls to manage the controlled devices 335 based on a “[device, action]” input. The device control agent 512 can be implemented using Retrieval Augmented Generation (RAG), where relevant data is extracted from device API documentation based on input from the device control agent 512. This data is then incorporated into the LLM prompt as context to produce legitimate API calls. The Q&A agent 513 is a general chat LLM that can answer daily life questions. The web search agent 514 is an LLM agent integrated with web search capabilities, enabling it to obtain current information from the web, including weather and time.

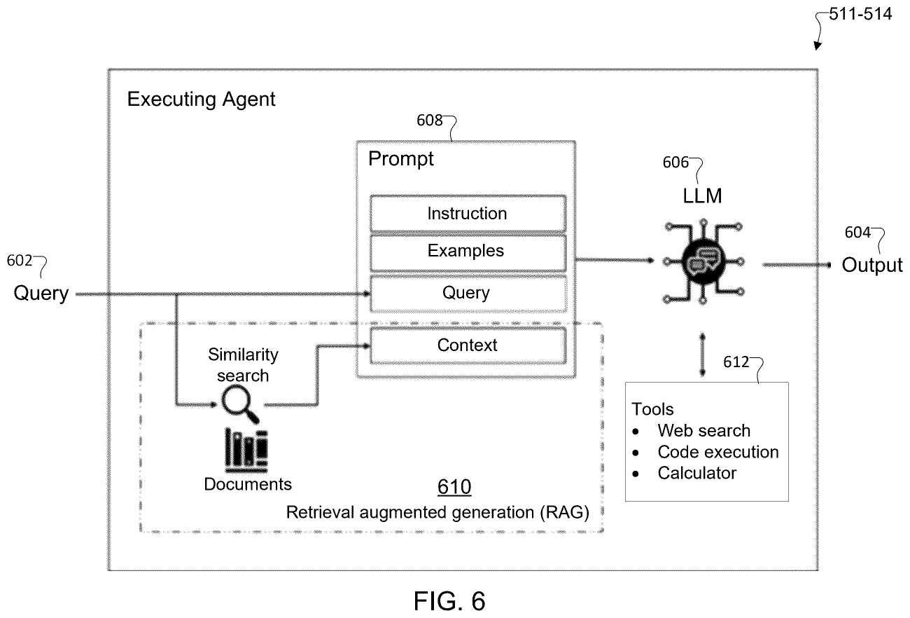

FIG. 6 illustrates an example architecture for the execution agents 511-514 according to embodiments of the present disclosure. As shown in FIG. 6, each execution agent 511-514 receives a query 602 from the core agent 505 and generates an output 604 using the corresponding LLM 606. The query 602 is configured into one or more prompts 608 for the LLM 606. The prompts 608 can include an instruction and examples (such as [input, output] examples) that define the role and expected output of the LLM 606. A RAG function 610 searches from local documents and provides query-relevant context to the LLM 606. Various tools 612 equip the LLM 606 with external functions such as web search, code execution, and calculation. By strategically choosing these components and designing their respective details, different execution agents 511-514 with diverse functionalities can be created.

Note that the specific components illustrated in FIGS. 3 through 6 are provided as possible examples, and it should not be construed that all are necessary to constitute a home assistant solution. This disclosure does not preclude using a subset or additional devices aligning with the design as disclosed here.

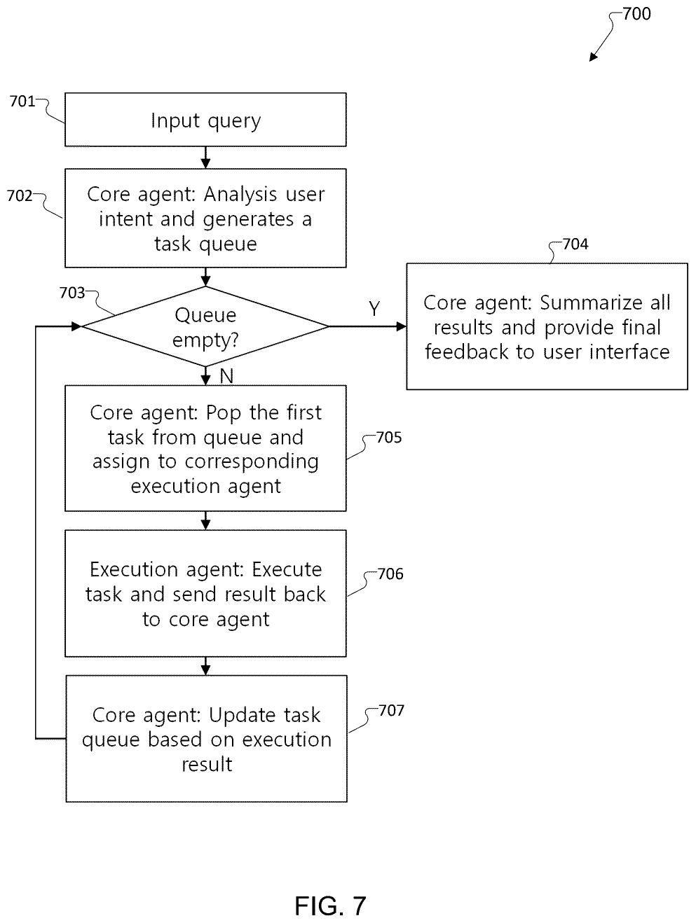

FIG. 7 illustrates an example process 700 for implementing a multi-agent home assistant system according to embodiments of the present disclosure. For ease of explanation, the process 700 is described as being performed using the system 300 of FIG. 3.

At operation 701, an input query is received from the user interface 330.

At operation 702, the core agent 505 analyzes the user intent from the input query and generates a list of tasks to fulfill the query. In some embodiments, the task list is presented in a task queue format.

At operation 703, the core agent 505 checks if the task queue is empty. If the task queue is empty, then the process 700 goes to operation 704. Otherwise, the process 700 goes to operation 705.

At operation 704, the core agent 505 summarizes the results from the previous operations and provides final feedback to the user interface 330.

At operation 705, the core agent 505 pops the first task from the task queue, and assigns the task to a corresponding execution agent 511-514.

At operation 706, the execution agent 511-514 performs the task and sends results back to the core agent 505.

At operation 707, the core agent 505 evaluates if the task list needs to be modified or updated based on the execution result from operation 706. Then, the process 700 returns to operation 703.

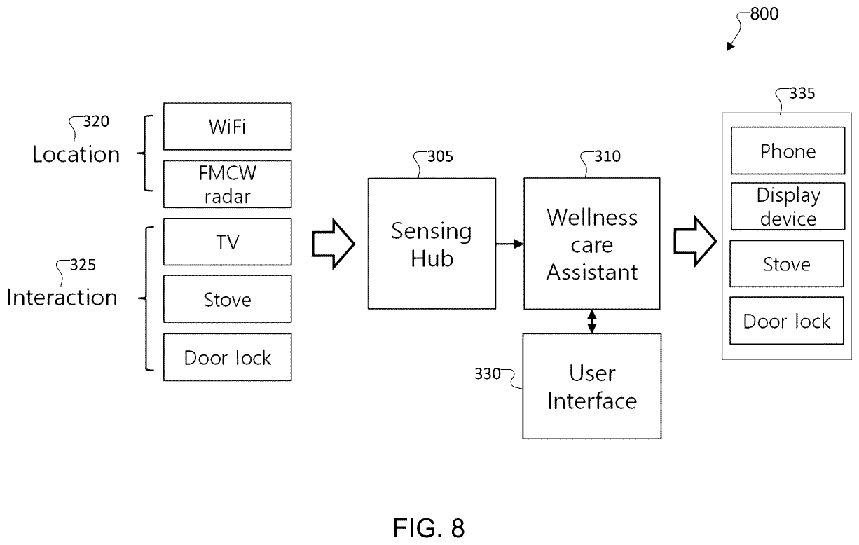

FIGS. 8 through 11 illustrate example use cases 800, 900, 1000, and 1100 for a multi-agent home assistant system according to embodiments of the present disclosure. The use cases 800, 900, 1000, and 1100 illustrate four exemplary applications, namely wellness care, entertainment, energy preserving, and home security. For ease of explanation, the use cases 800, 900, 1000, and 1100 are described in the context of the system 300 of FIG. 3.

As shown in FIG. 8, the system 300 is configured for a wellness care use case 800. In this scenario, a senior family member lives at home, and his or her location or motion information is collected by one or more non-wearable devices 320, such as Wi-Fi, FMCW radar, UWB radar, ultrasound devices, and the like. Also, his or her interactions with various smart home appliances 325, such as TV, stove, door lock, and the like, are recorded by those devices. All sensing information is processed by the sensing hub 305 and sent to the home assistant module 310, which operates here as a wellness care assistant. This home assistant module 310 utilizes LLM in the context of wellness care, outputting relevant suggestions and actions.

The following is an example list of use cases for wellness care:
Incident detection: (sensor data) people in bathroom for 1 hour and no motion detected for 15 mins->(LLM conclusion) user possibly fell in bathroom->(LLM action) call caregiver or 911 for assistance.
Hazard prevention: (sensor data) stove is turned on high, front door opened and closed 10 mins ago, last location outside front door 10 mins ago->(LLM conclusion) user went for a walk but left stove on->(LLM action) Turn off stove, contact user or caregiver.
Health suggestion: (sensor data) location shift frequently between bathroom and bedroom during night->(LLM conclusion) possible heath issue due to frequent bathroom use->(LLM action) suggest doctor visit and call caregiver for attention.

Note that in above examples, the user interface 330 could generate periodic queries, such as “How is the user doing?”, to trigger LLM reasoning.

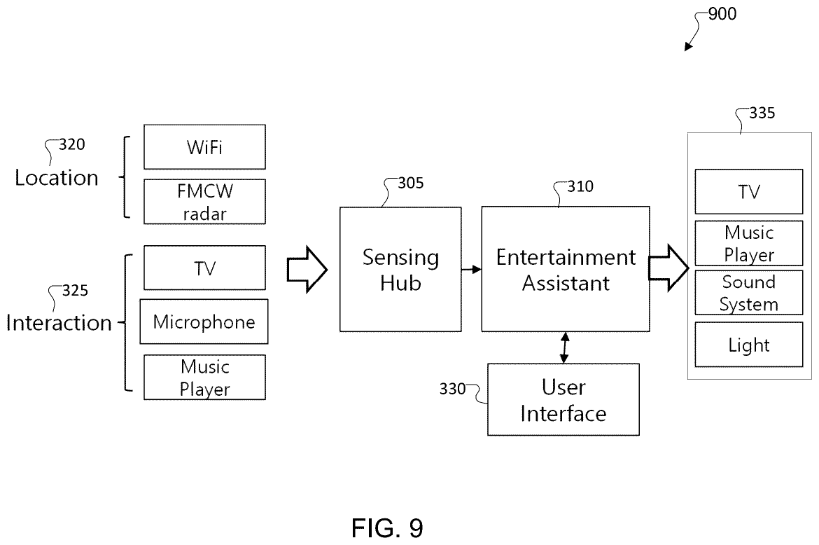

As shown in FIG. 9, the system 300 is configured for an entertainment use case 900. In this scenario, user location information is collected by one or more non-wearable devices 320, such as Wi-Fi, FMCW radar, and the like. Also, the user's interactions with various smart home appliances 325, such as TV, microphone, music player, and the like, are recorded by those devices. This sensing information is processed by the sensing hub 305 and sent to the home assistant module 310, which operates here as an entertainment assistant. The home assistant module 310 infers user preference, mood, and activity pattern. When the user asks the entertainment assistant to turn on TV or play music through the user interface 330, the entertainment assistant determines (1) which device(s) to turn on, how to set the volume/light based on user location, and (2) what content to play based on the user preference and mood.

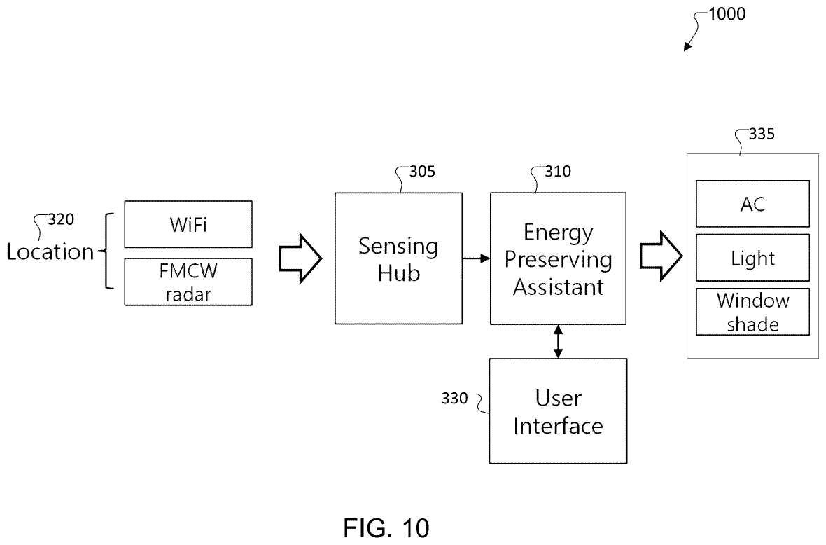

As shown in FIG. 10, the system 300 is configured for an energy preserving use case 1000. In this scenario, user presence and location information are collected by one or more non-wearable devices 320, such as Wi-Fi, FMCW radar, UWB radar, ultrasound devices, and the like, and processed by the sensing hub 305. Then the home assistant module 310, which operates here as an energy preserving assistant, can adjust various controlled devices 335, such as an AC temperature setting based on user presence and location, or control light and window shade based on user presence, time of day, and position of sun, such that home energy usage is optimized. Here, the user interface 330 can be configured to periodically query the home assistant module 310 if new energy preserving actions are needed.

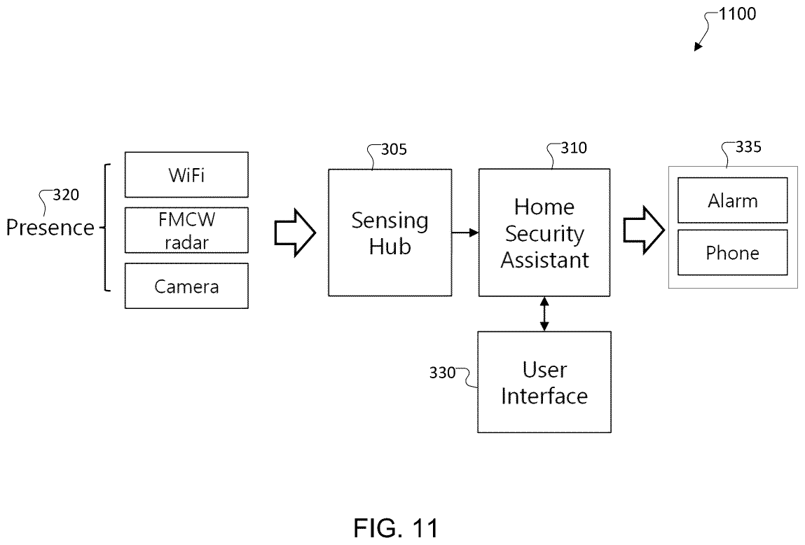

As shown in FIG. 11, the system 300 is configured for a home security use case 1100. In this scenario, human presence information is collected by one or more non-wearable devices 320, such as Wi-Fi, FMCW radar, UWB radar, security camera, and the like, processed by the sensing hub 305. and sent to the home assistant module 310, which operates here as a home security assistant. The user (e.g., a homeowner) can set restricted areas through the user interface 330. Based on human presence information and restricted area settings, the home security assistant can identify and alert of intruders approaching the home as early warning, and sound an alarm or call 911 if a physical break-in in a restricted area is detected.

Although FIGS. 3 through 11 illustrate example techniques for implementing a LLM-based home assistant and related details, various changes may be made to FIGS. 3 through 11. For example, various components in FIGS. 3 through 11 could be combined, further subdivided, or omitted and additional components could be added according to particular needs. In addition, while shown as a series of steps, various operations in FIGS. 3 through 11 could overlap, occur in parallel, occur in a different order, or occur any number of times. In another example, steps may be omitted or replaced by other steps.

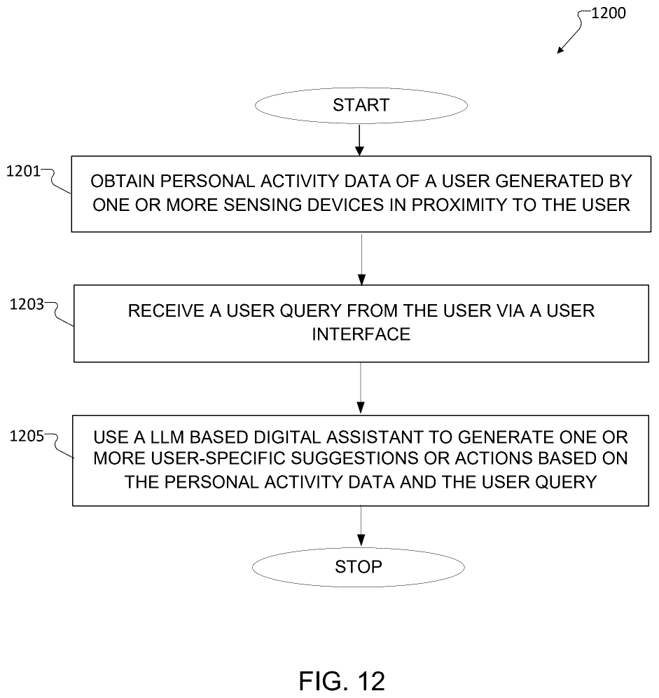

FIG. 12 illustrates a flow chart of a method 1200 for implementing a LLM-based home assistant according to embodiments of the present disclosure, as may be performed by one or more components of the wireless network 100 (e.g., the AP 101 or the STA 111) implementing the system 300. The embodiment of the method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

As illustrated in FIG. 12, the method 1200 begins at step 1201. At step 1201, a device obtains personal activity data of a user generated by one or more sensing devices in proximity to the user. This could include, for example, the STA 111 obtaining user presence and location information, motion data, user-device interaction data, and the like, which is generated by one or more wearable devices 315, non-wearable devices 320, or smart home appliances 325, as shown in FIG. 3.

At step 1203, the device receives a user query from the user via a user interface. This could include, for example, the STA 111 receiving a user query from the user via the user interface 330, as shown in FIG. 3.

At step 1205, the device uses a LLM based digital assistant to generate one or more user-specific suggestions or actions based on the personal activity data and the user query. The digital assistant has a hierarchical multi-LLM-agent structure that includes one or more pre-trained LLMs. This could include, for example, the STA 111 using the home assistant module 310 to generate one or more user-specific suggestions or actions, as shown in FIG. 3.

In some embodiments, the hierarchical multi-LLM-agent structure includes (i) a core agent 505 configured to generate one or more tasks to be performed, and (ii) multiple execution agents 511-514 configured to perform the one or more tasks, where at least one of the execution agents comprises at least one of the one or more pre-trained LLMs.

In some embodiments, using the LLM based digital assistant to generate the one or more user-specific suggestions or actions based on the personal activity data and the user query can include the following operations (such as shown in FIG. 7): determining, by the core agent, a user intent based on the user query and generating a task queue comprising the one or more tasks; performing each of the one or more tasks using at least one of the multiple execution agents; updating the task queue using the core agent after each of the one or more tasks is performed; and generating the one or more user-specific suggestions or actions.

Although FIG. 12 illustrates one example of a method 1200 for implementing a LLM-based home assistant, various changes may be made to FIG. 12. For example, while shown as a series of steps, various steps in FIG. 12 could overlap, occur in parallel, occur in a different order, or occur any number of times.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
obtaining personal activity data of a user generated by one or more sensing devices in proximity to the user;
receiving a user query from the user via a user interface; and
using a large language model (LLM) based digital assistant to generate one or more user-specific suggestions or actions based on the personal activity data and the user query, the digital assistant comprising a hierarchical multi-LLM-agent structure that includes one or more pre-trained LLMs.

2. The method of claim 1, wherein the hierarchical multi-LLM-agent structure comprises:
a core agent configured to generate one or more tasks to be performed; and
multiple execution agents configured to perform the one or more tasks, at least one of the execution agents comprising at least one of the one or more pre-trained LLMs.

3. The method of claim 2, wherein the multiple execution agents comprise at least one of: a database agent, a device control agent, a question/answer agent, and a web search agent.

4. The method of claim 2, wherein using the LLM based digital assistant to generate the one or more user-specific suggestions or actions based on the personal activity data and the user query comprises:
determining, by the core agent, a user intent based on the user query and generating a task queue comprising the one or more tasks;
performing each of the one or more tasks using at least one of the multiple execution agents;
updating the task queue using the core agent after each of the one or more tasks is performed; and
generating the one or more user-specific suggestions or actions.

5. The method of claim 4, wherein the one or more user-specific suggestions or actions comprise control of the one or more sensing devices or another device.

6. The method of claim 1, wherein the digital assistant is implemented in at least one of a cloud server or a user application.

7. The method of claim 1, wherein the one or more sensing devices comprise at least one of a motion sensor, a home appliance, or a wearable device.

8. A device comprising:
a transceiver; and
a processor operably connected to the transceiver, the processor configured to:
obtain personal activity data of a user generated by one or more sensing devices in proximity to the user;
receive a user query from the user via a user interface; and
use a large language model (LLM) based digital assistant to generate one or more user-specific suggestions or actions based on the personal activity data and the user query, the digital assistant comprising a hierarchical multi-LLM-agent structure that includes one or more pre-trained LLMs.

9. The device of claim 8, wherein the hierarchical multi-LLM-agent structure comprises:
a core agent configured to generate one or more tasks to be performed; and
multiple execution agents configured to perform the one or more tasks, at least one of the execution agents comprising at least one of the one or more pre-trained LLMs.

10. The device of claim 9, wherein the multiple execution agents comprise at least one of: a database agent, a device control agent, a question/answer agent, and a web search agent.

11. The device of claim 9, wherein to use the LLM based digital assistant to generate the one or more user-specific suggestions or actions based on the personal activity data and the user query, the processor is configured to:
determine, using the core agent, a user intent based on the user query and generate a task queue comprising the one or more tasks;
perform each of the one or more tasks using at least one of the multiple execution agents;
update the task queue using the core agent after each of the one or more tasks is performed; and
generate the one or more user-specific suggestions or actions.

12. The device of claim 11, wherein the one or more user-specific suggestions or actions comprise control of the one or more sensing devices or another device.

13. The device of claim 8, wherein the digital assistant is implemented in at least one of a cloud server or a user application.

14. The device of claim 8, wherein the one or more sensing devices comprise at least one of a motion sensor, a home appliance, or a wearable device.

15. A non-transitory computer readable medium comprising program code that, when executed by a processor of a device, causes the device to:
obtain personal activity data of a user generated by one or more sensing devices in proximity to the user;
receive a user query from the user via a user interface; and
use a large language model (LLM) based digital assistant to generate one or more user-specific suggestions or actions based on the personal activity data and the user query, the digital assistant comprising a hierarchical multi-LLM-agent structure that includes one or more pre-trained LLMs.

16. The non-transitory computer readable medium of claim 15, wherein the hierarchical multi-LLM-agent structure comprises:
a core agent configured to generate one or more tasks to be performed; and
multiple execution agents configured to perform the one or more tasks, at least one of the execution agents comprising at least one of the one or more pre-trained LLMs.

17. The non-transitory computer readable medium of claim 16, wherein the multiple execution agents comprise at least one of: a database agent, a device control agent, a question/answer agent, and a web search agent.

18. The non-transitory computer readable medium of claim 16, wherein the program code to use the LLM based digital assistant to generate the one or more user-specific suggestions or actions based on the personal activity data and the user query, comprises program code to:
determine, using the core agent, a user intent based on the user query and generate a task queue comprising the one or more tasks;
perform each of the one or more tasks using at least one of the multiple execution agents;
update the task queue using the core agent after each of the one or more tasks is performed; and
generate the one or more user-specific suggestions or actions.

19. The non-transitory computer readable medium of claim 18, wherein the one or more user-specific suggestions or actions comprise control of the one or more sensing devices or another device.

20. The non-transitory computer readable medium of claim 15, wherein the digital assistant is implemented in at least one of a cloud server or a user application.
